(19) United States
(12) Patent Application Publication
(10) Pub. No.: US 2007/0170172 A1
(43) Pub. Date: Jul. 26, 2007

(54) Fixing device and image forming apparatus

(75) Inventors: Yutaka Otsuka, Toyokawa-shi (JP); Yoshihisa Fujimoto, Toyohashi-shi (JP); Koji Takahashi, Toyokawa-shi (JP); Naoki Yamamoto, Toyohashi-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/589,857

(22) Filed: Oct. 31, 2006

(30) Foreign Application Priority Data
Jan. 26, 2006 (JP) 2006-017229

(51) Int. Cl. G03G 15/20; H05B 6/14

(52) U.S. Cl. 219/619; 399/328

(57) ABSTRACT

A Fixing device has a heat roller, a magnetic flux generating element, and a magnetic flux block section. The magnetic flux block section for blocking magnetic flux flowing from a magnetic flux generating element to a heat roller is moved to a position at which the magnetic flux does not cause the heat roller to generate heat when rotation of the heat roller stops. The magnetic flux block section is moved to a position at which the heat roller generates heat when the heat roller rotates. Therefore, when rotation of the heat roller stops, even if electric current is applied to the magnetic flux generating element to generate magnetic flux from the magnetic flux generating element, heat generation by the magnetic flux generating element is prevented, so that smoking and firing of the heating element is suppressed.

### CROSS-REFERENCE TO RELATED APPLICATIONS

This application is based on the application No. 2006-017229 filed in Japan, the entire content of which is hereby incorporated by reference.

### BACKGROUND OF THE INVENTION

The present invention relates to a fixing device for use in electrophotographic image forming apparatuses such as copying machines, laser printers or facsimiles, and relates to an image forming apparatus with use of the fixing device.

In recent years, the warm-up period of fixing devices has become shorter and shorter for the sake of energy saving and reduction of working hours. That is, a heat roller in the fixing devices is rapidly heated.

However, when heating the heat roller in a stopped state, the temperature rise rate of the heat rollers is increased. Eventually, it becomes impossible for an overheat protector such as a thermostat or fuse to prevent the heat rollers from catching fire.

Accordingly, as an example of conventional fixing devices, the heat roller is heated by magnetic flux from an coil while the heat roller is rotating, wherein magnetic flux is generated by applying electric current to the coil (JP 2002-82549 A). In other words, catching fire on the heat roller is suppressed by avoiding the increase in the temperature rise rate of the heat roller.

In the conventional fixing device, however, there has been a problem that the heat roller may be overheated to catch fire when an electric current is applied to the coil in the stopped state of the heat roller due to some sort of error.

### BRIEF SUMMARY OF THE INVENTION

An object of the present invention is to provide a fixing device which prevents the heat roller from catching fire even if electric current is applied to the coil when the heat roller stops.

In order to achieve the above-mentioned object, one aspect of the present invention provides a fixing device, comprising:

a magnetic flux generating element for generating magnetic flux;

a rotatable heating element for generating heat by magnetic flux from the magnetic flux generating element;

a magnetic flux block section placed movably into between the magnetic flux generating element and the heating element and blocking at least part of the magnetic flux flowing from the magnetic flux generating element to the heating element when being positioned between the magnetic flux generating element and the heating element;

a movement control section for moving the magnetic flux block section to a position at which the magnetic flux from the magnetic flux generating element causes the heating element to generate no heat when rotation of the heating element stops, whereas moving the magnetic flux block section to a position at which the magnetic flux from the magnetic flux generating element causes the heating element to generate heat when the heating element rotates.

According to the fixing device in the present invention, the movement control section moves the magnetic flux block section to a position at which the magnetic flux from the magnetic flux generating element does not cause the heating element to generate heat when rotation of the heating element stops. On the other hand, the movement control section moves the magnetic flux block section to a position at which the magnetic flux from the magnetic flux generating element causes the heating element to generate heat when the heating element rotates. Therefore, when rotation of the heating element stops, even if electric current is applied to the magnetic flux generating element to generate magnetic flux from the magnetic flux generating element, heat generation by the magnetic flux generating element is prevented, so that smoking and firing of the heating element can be suppressed. This makes it possible to achieve a high-security fixing device.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a cross sectional view of a fixing device in a first embodiment of the present invention;

FIG. 2 is a side view of the fixing device as viewed from an axial end side of a heat roller;

FIG. 3 is a partially cut perspective view of a damper;

FIG. 4A is an operation explanation view of a magnetic flux block section to show a position thereof in the case where the rotation speed of the heat roller is low;

FIG. 4B is an operation explanation view of the magnetic flux block section to show a position thereof in the case where the rotation speed of the heat roller is high;

FIG. 5 is a simplified structure view of a fixing device in a second embodiment of the present invention;

FIG. 6 is a simplified structure view of a fixing device in a third embodiment of the present invention; and

FIG. 7 is a simplified structure view of an image forming apparatus according to the present invention.

### DETAILED DESCRIPTION OF THE INVENTION

Hereinbelow, the invention will be described in detail in conjunction with the embodiments with reference to the drawings.

### First Embodiment

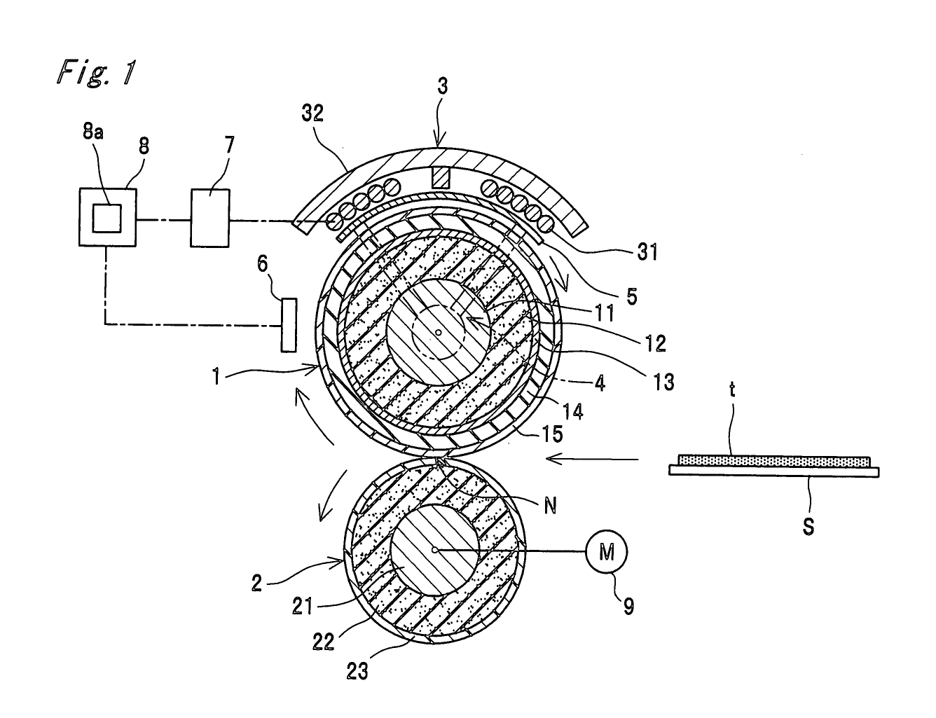

FIG. 1 is a cross sectional structure view of a fixing device in a first embodiment of the present invention. The fixing device has a heat roller 1, a pressure roller 2 and a magnetic flux generating element 3. The heat roller 1 serves as a rotatable heating element. The pressure roller 2 serves as a pressing element coming into pressure contact with the heat roller 1. The magnetic flux generating element 3 is placed outside the heat roller 1 for generating magnetic flux to make the heat roller 1 generate heat.

A magnetic flux block section 5 is placed between the magnetic flux generating element 3 and the heat roller 1 in such a way that the magnetic flux block section 5 can move between the magnetic flux generating element 3 and the heat roller 1 in the rotation direction (circumferential direction) of the heat roller 1. A movement control section 4 is provided to move the magnetic flux block section 5 to a specified position in the rotation direction (circumferential direction) of the heat roller 1.

The heat roller 1 and the pressure roller 2 contact with each other to fix a toner t of a recording member S while transporting the recording member S. More specifically, the heat roller 1 and the pressure roller 2 contact with each other to form a nip section N, wherein the heat roller 1 generates heat by magnetic flux from the magnetic flux generating element 3, and then the nip section N transports a recording member S while melting and fixing the toner t on the recording member S.

The recording member S is exemplified by sheets such as paper sheets and OHP sheets. The toner t is made of thermally meltable materials such as resins, magnetic materials and colorants.

The heat roller 1 and the pressure roller 2 are placed parallely facing each other. Both the ends of the respective rollers are rotatably supported by unshown bearing members. The heat roller 1 and the pressure roller 2 freely come close to or away from each other.

The pressure roller 2 is rotationally driven counterclockwise as shown by an arrow at a specified peripheral velocity by a motor 9 serving as a drive section. The heat roller 1 rotates in a clockwise direction as shown by an arrow, following after the rotation of the pressure roller 2, wherein the rotation results from a friction force attained by pressure contact between the heat roller 1 and the pressure roller 2 at the nip section N.

The heat roller 1 has an outer diameter of 40 mm for example. The heat roller 1 has a support layer 11, a heat insulating layer 12, an electromagnetic induction heat generating layer 13, an elastic layer 14 and a release layer 15 which are placed in sequence from the inside toward the outside in the radial direction. Although the heat roller 1 has the elastic layer 14 for supporting color images in this embodiment, the heat roller 1 has only to have at least the support layer 11, the heat insulating layer 12, the electromagnetic induction heat generating layer 13 and the release layer 15.

For the support layer 11, a cylinder shaft may be used, which is made of steel and has an outer diameter of 30 mm for example. A heat-resistant molded pipe made of, for example, polyphenylene sulfide (PPS) may also be used for the support layer 11 as long as the material strength thereof is ensured. However, nonmagnetic material such as aluminum is preferably used for the support layer 11 in order to prevent the shaft from generating heat since the nonmagnetic material hardly generates heat by electromagnetic induction.

The heat insulating layer 12 is for insulating and retaining heat generated by the electromagnetic induction heat generating layer 13. The heat insulating layer 12 is made of sponges (heat insulating structures) made from rubber materials and resin materials having not only heat resistance but also elasticity. For the heat insulating layer 12, the use of sponges (heat insulating structures) made from rubber materials and resin materials having high heat resistance and high elasticity makes it possible to reliably insulate the electromagnetic induction heat generating layer 13 and to allow deflection of the electromagnetic induction heat generating layer 13. Thus, it becomes possible to enhance performance of sheet discharge and performance of recording member separation by increasing a width size of the nip section N and by making the roller hardness of the heat roller 1 lower than that of the pressure roller 2. In the case where the heat insulating layer 12 is made of a silicon sponge material for example, its thickness is set at 2 mm to 10 mm, preferably 3 mm to 7 mmm and its hardness is set at 20 to 60 degrees, preferably 30 to 50 degrees according to an Asker rubber hardness meter.

The electromagnetic induction heat generating layer 13 is, for example, an endless electroformed nickel belt layer with a thickness of 10 to 100 μm and preferably 20 to 50 μm. As other materials of the electromagnetic induction heat generating layer 13, it is acceptable to use magnetic materials (magnetic metals), such as magnetic stainless steels, which have a relatively high magnetic permeability μ and an appropriate resistivity ρ. Even if materials are nonmagnetic, materials having electric conductivity such as nonmagnetic metals may be used by forming them into thin films for example. Moreover, materials in which heat generating particles are dispersed in resin may be used for the electromagnetic induction heat generating layer 13. The electromagnetic induction heat generating layer 13 made of resin-based materials makes it possible to further enhance the separating performance of the recording member S. The electromagnetic induction heat generating layer 13 is bonded onto the heat insulating layer 12.

In the electromagnetic induction heat generating layer 13, an eddy current is generated by magnetic flux from the magnetic flux generating element 3 so as to generate Joule heat, by which the heat roller 1 is heated. This heating is referred to as electromagnetic induction heating.

The elastic layer 14 is made of a rubber material or a resin material having not only heat resistance but also elasticity so as to promotes adhesion between the recording member S and the surface of the heat roller 1. Heat-resistant elastomer such as silicon rubber or fluorocarbon rubber is used as the elastic layer 14, which rubber can withstand use at fixing temperatures. Various fillers may be mixed with the elastic layer 14 for the purpose of enhancing thermal conductivity, reinforcement or the like. Examples of thermally conductive particles include diamond, silver, copper, aluminum, marble and glass. Practical examples thereof include silica, alumina, magnesium oxide, boron nitride and beryllium oxide.

The thickness of the elastic layer 14 should preferably be, for example, 10 μm to 800 μm and more preferably be 100 μm to 300 μm. If the thickness of the elastic layer 14 is less than 10 μm, it is difficult to attain elasticity in the thickness direction. On the other hand, if the thickness of the elastic layer 14 exceeds 800 μm, it is difficult for heat generated in the electromagnetic induction heat generating layer 13 to reach the outer peripheral face of the heat roller 1. As the result, there is a tendency for the thermal efficiency to deteriorate.

The hardness of the elastic layer 14 should be 1 to 80 degrees and preferably 5 to 30 degrees in JIS hardness scale. Then, it is possible to prevent failure in fixing of toner t while preventing degradation in strength and failure in adhesion of the elastic layer 14. In this case, the elastic layer 14 is preferably made of silicon rubber. Specifically, the silicon rubber are one-component, two-component or three or more-component silicon rubbers, LTV-type, RTV-type or HTV-type silicon rubbers, and condensation-type or addition-type silicon rubbers. In this embodiment, the elastic layer 14 is a silicon rubber having a JIS hardness of 10 degree and a thickness of 200 μm.

The release layer 15 is for enhancing the releasing property of the surface of the fixing roller 1. The release layer 15 withstands any uses at fixing temperatures and has the property of releasing toner. For example, silicon rubber, fluorocarbon rubber or fluorocarbon resin such as PFA, PTFE, FEP or PFEP is used for the release layer 15. The thickness of the release layer 15 is preferably 5 μm to 100 μm and more preferably 10 μm to 50 μm. In order to enhance an interlayer adhesion force, adhesion processing may be performed by using a primer or the like. According to need, the release layer 15 may contain conductive material, abrasion-resistant material and/or good thermal conductive material as fillers.

The pressure roller 2 has for example 30mm of outer diameter, and has a support layer 21, a heat insulating layer 22 and a release layer 23, which are placed in sequence from the inside toward the outside of the pressure roller 2 in the radial direction. The support layer 21 is made out of, for example, a steel hollow shaft having an outer diameter of 20 mm. The heat insulating layer 22 is made out of, for example, a silicon sponge rubber formed by foaming silicon rubber having a thickness of 3 to 10 mm. The release layer 23 is made out of, for example, fluorocarbon resin such as PTFE or PFA having a thickness of 10 to 50 μm.

The material of the support layer 21 may be a heat-resistant molded pipe made of, for example, PPS (polyphenylene sulfide) as long as the strength can be ensured. However, in order to prevent the shaft from generating heat, it is preferable to use nonmagnetic material such as aluminum which is less heated by electromagnetic induction.

The pressure roller 2 is pressed toward the heat roller 1 with a load of 300 to 530N. In this case, a width size of the nip section N (i.e. size thereof in the transportation direction of the recording member S) is about 5 to 15 mm. A longitudinal size of the nip section N (i.e. size thereof in axial direction of the heat roller 1) is about 340 mm. The width size of the nip section N may be changed by changing the load.

The magnetic flux generating element 3 faces the heat roller 1 in such a way that the magnetic flux generating element 3 extends along the longitudinal direction of the heat roller 1. The magnetic flux generating element 3 has a magnetic core 32 and a coil 31. The magnetic core 32 is placed outside along the outer face of the heat roller 1. The coil 31 is placed on a surface of the core 32 which surface faces the heat roller 1.

The core 32 is shaped into a circular-arc extending along the outer face of the heat roller 1 in a transverse sectional view. The coil 31 has such a structure that a conductive wire is wound along the inner face of the coil 31 so as to be longer in the axial direction of the heat roller 1. The coil 31 has a roughly trapezoidal shape in the transverse sectional view.

The magnetic core 32 having high magnetic permeability and low loss are generally used. The magnetic core 32 is used so as to increase the efficiency of magnetic circuits and to shield magnetism. Ferrite cores are usually used for material of the magnetic core 32. However, in the case where alloy such as permalloy is used, the magnetic core 32 may have a laminated structure since radio frequencies may cause an eddy current loss to be increased in the magnetic core 32. In addition, in the case of using resin material with magnetic powders dispersed therethrough, the magnetic permeability becomes relatively low. Thereby, however, the magnetic core 32 is freely shaped.

The central portion of the magnetic core 32 in the rotation direction of the heat roller 1 has a protrusion protruding toward the heat roller 1, so that the heat generation efficiency of the heat roller 1 is enhanced. The protrusion may be removed if there is a mechanism to provide sufficient magnetic shielding in the magnetic circuit section which is formed by the coil 31 and the core 32.

An RF converter 7 is connected to the coil 31 to supply a radio frequency power of 100 to 2000 W, for example. A Litz wire, which is formed by bunching or twisting several dozen to several hundred thin wires, is used as the coil 31. The Litz wire is coated with heat-resistant resin in consideration of heat conducted to the winding wires.

An alternating current of, for example, 10 to 100 kHz is applied to the coil 31 by the converter 7. The magnetic flux induced by the alternating current penetrates the electromagnetic induction heat generating layer 13 of the heat roller 1 from the core 32. This causes eddy current to flow through the electromagnetic induction heat generating layer 13. Thereby, the electromagnetic induction heat generating layer 13 generates Joule heat. The heat roller 1 is heated by the heat generated in the electromagnetic induction heat generating layer 13.

A temperature sensor 6 for detecting the temperature of the heat roller 1 is placed outside the heat roller 1. The temperature sensor 6 is, for example, a noncontact-type thermister and placed away from the surface of the heat roller 1.

The temperature sensor 6 is connected to a main control section 8. The main control section 8 controls the converter 7 based on a surface temperature detection signal of the heat roller 1 from the temperature sensor 6. Specifically, the surface temperature of the heat roller 1 is automatically controlled to become a specified constant temperature by increasing or decreasing power supply to the coil 31 in the converter 7. The main control section 8 has a converter control section 8a which turns off application of electric current to the converter 7 when rotation of the heat roller 1 stops.

The magnetic flux block section 5 blocks at least part of magnetic flux flowing from the magnetic flux generating element 3 to the heat roller 1 when the magnetic flux block section 5 positions between the magnetic flux generating element 3 and the heat roller 1. The magnetic flux block section 5 is made of nonmagnetic metal materials having good conductivity, such as alloys of aluminum, copper, silver or the like. Thereby, the magnetic flux is blocked to suppress heating caused by induction current. The magnetic flux block section 5 has a plate shape curved along the outer face of the heat roller 1.

In the rotation direction of the heat roller 1, the surface size of the magnetic flux block section 5 is almost identical to the inner surface size of the magnetic flux generating element 3. In the axial direction of the heat roller 1, the magnetic flux block section 5 can exist outside the end section of the heat roller 1.

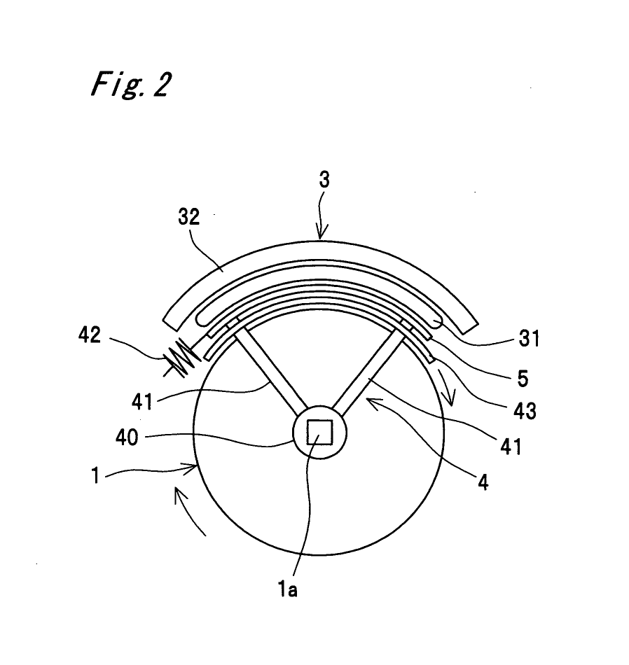

FIG. 2 shows a side view of the end section of the heat roller 1. As shown in FIG. 2, the movement control section 4 moves the magnetic flux block section 5 to the position where the magnetic flux from the magnetic flux generating element 3 does not cause the heat roller 1 to generate heat when the heat roller 1 does not rotate. On the other hand, the movement control section 4 moves the magnetic flux block section 5 to the position where the magnetic flux from the magnetic flux generating element 3 causes the heat roller 1 to generate heat when the heat roller 1 rotates.

More particularly, when the heat roller 1 stops, the movement control section 4 moves the magnetic flux block section 5 to the position where the magnetic flux flowing from the magnetic flux generating element 3 to the heat roller 1 is completed blocked. The state of the magnetic flux block section 5 at this point of time is referred to as a close state of the magnetic flux block section 5, in which the magnetic flux block section 5 covers the entire region between the heat roller 1 and the magnetic flux generating element 3.

When the heat roller 1 rotates, the movement control section 4 moves the magnetic flux block section 5 in an arrow direction in conjunction with the rotation of the heat roller 1 in the arrow direction. The state of the magnetic flux block section 5 at this point of time is referred to as an open state of the magnetic flux block section 5.

More specifically, the movement control section 4 has a damper 40 mounted on a shaft section la of the heat roller 1, a coupling rod 41 fixed onto the damper 40, the magnetic flux block section 5 fixed onto the coupling rod 41 and a tension spring 42 attached to the magnetic flux block section 5.

A turning effect of the shaft section la of the heat roller 1 is transmitted to the magnetic flux block section 5 through the damper 40. The magnetic flux block section 5 moves along a rail 43 fixed onto an unshown casing. The rail 43 has a plate shape curved along the outer face of the heat roller 1. The rail 43 is placed outside the end of the heat roller 1 so as not to disturb rotation of the heat roller 1. The rail 43 is not an essential component.

One end of the tension spring 42 is fixed onto an unshown casing, while the other end of the tension spring 42 is fixed onto the magnetic flux block section 5. The tension spring 42 constantly biases the magnetic flux block section 5 in such a way that the magnetic flux block section 5 moves to the position at which the heat roller 1 does not generate heat. Basically, the tension spring 42 pulls the magnetic flux block section 5 in a direction opposite to the direction that the magnetic flux block section 5 moves in conjunction with the rotation of the heat roller 1. More particularly, the tension spring 42 puts the magnetic flux block section 5 in the close state when the heat roller 1 stops.

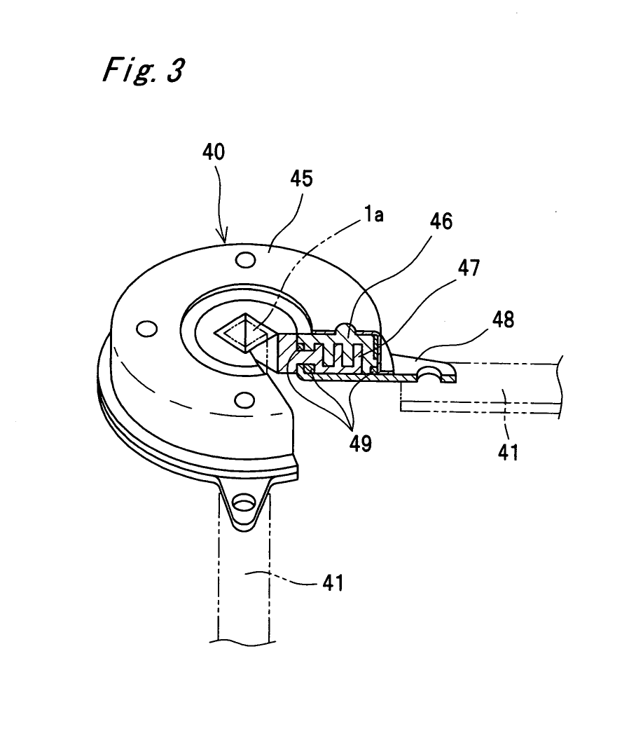

As shown in FIG. 3, the damper 40 is a disc damper. The damper 40 has a housing 45 and a rotor 47 mounted through a sheet 46. The housing 45 has a frame 48 onto which the coupling rod 41 is fixed. The shaft section la of the heat roller 1 is fixed onto the rotor 47. The sheet 46 is fixed onto the housing 45.

Each of O-rings 49 is partially provided between the sheet 46 and the rotor 47, between the frame 48 and the rotor 47 and between the frame 48 and the sheet 46.

Oil is filled between the rotor 47 and the sheet 46. A torque is generated by viscous resistance of the oil generated during relative rotation between the rotor 47 and the sheet 46.

More particularly, the sheet 46, the housing 45 and the coupling rod 41 rotate in the same direction as the rotor 47 by the viscosity of the oil when the rotor 47 rotates together with the shaft section la of the heat roller 1.

A higher rotation speed of the heat roller 1 increase the torque of the damper 40. On the other hand, a lower rotation speed of the heat roller 1 decreases the torque of the damper 40.

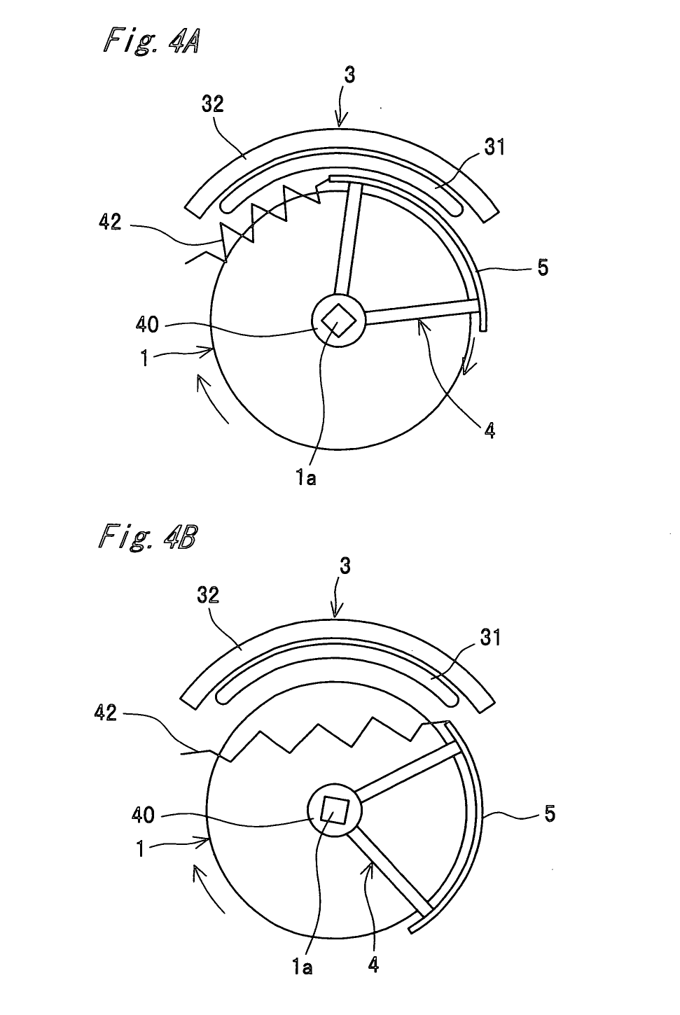

More particularly, as shown in FIGS. 4A and 4B, the movement control section 4 moves the magnetic flux block section 5 in such a way that an amount of a blocked magnetic flux flowing from the magnetic flux generating element 3 to the heat roller 1 decreases as the rotation speed of the heat roller 1 increases.

FIG. 4A shows the location of the magnetic flux block section 5 in the case of a peripheral velocity on the outer face of the heat roller 1 being 30 mm/s. The magnetic flux block section 5 is located in a half-close state and covers a half of the region between the heat roller 1 and the magnetic flux generating element 3.

FIG. 4B shows the location of the magnetic flux block section 5 in the case of a peripheral velocity on the outer face of the heat roller 1 being 60 mm/s. The magnetic flux block section 5 is located in a fully open state and exposes the entire region between the heat roller 1 and the magnetic flux generating element 3.

Therefore, when the peripheral velocity of the outer face of the heat roller 1 becomes double, the amount of the magnetic flux flowing from the magnetic flux generating element 3 to the heat roller 1 becomes double.

When the heat roller 1 rotates, force larger than the force generated by the tension spring 42 is generated in the damper 40. When rotation of the heat roller 1 stops, the tension spring 42 pulls the magnetic flux block section 5 against the viscous resistance in the damper 40.

Description is now given of operations of the above-structured fixing device.

An operation for heating the surface of the heat roller 1 and the surface of the pressure roller 2 up to a printable temperature after the fixing device is powered on is called a warm-up operation. A time taken for the operation is called a warm-up time. The warm-up operation also runs at the times of power cycle, recovery from jamming processing, cover close, and recovery from a sleep mode.

In the warm-up operation, for gaining the printable temperature, electric current is applied to the coil 31 by the main control section 8 shown in FIG. 1, and thereby the electromagnetic induction heat generating layer 13 of the heat roller 1 generates heat.

Then, the pressure roller 2 is rotated by the motor 9 so as to rotate the heat roller 1 following after rotation of the pressure roller 2, and thereby heat of the heat roller 1 is transmitted to the surface of the pressure roller 2. This rotation allows the surface of the heat roller 1 and the surface of the pressure roller 2 to be heated to the printable temperature in shorter period of time.

The temperature of the heat roller 1 is detected in a noncontact way by the temperature sensor 6. The temperature of the heat roller 1 is corrected by a temperature shift caused by the noncontact. When the corrected temperature reaches a specified printable temperature, the fixing device becomes “ready” which indicate a printable state. Specifically, the fixing device becomes “ready” when the corrected temperature, which is based on the detected temperature of the temperature sensor 6, reaches for example 190° C.

When a print signal is not present, the system is put in a print standby state. When the print signal is present, a printing operation starts. During the standby state, current application is controlled by the main control section 8 so as to keep a specified set temperature in the state of rotation or no rotation of the heat roller 1. The specified set temperature of the heat roller 1 is, for example, 190° C.

At the time of printing, the temperature of the pressure roller 2 have been increased by conducting heat of the heat roller 1 to the pressure roller 2, before the recording member S enters the fixing device. In this case, the temperature rise speed is about 50° C./s when the heat roller 1 is in a stopped state, whereas the temperature rise speed is about 25° C./s when the heat roller 1 rotates.

The fixing device is equipped with an unshown excessive temperature rise prevention device as a safety device. The excessive temperature rise prevention device is a thermostat for example. The thermostat is placed in the vicinity of the magnetic flux generating element 3 so as to detect the surface temperature of the heat roller 1 in a noncontact state. In consideration of preventing malfunction other than excessive temperature rise, the temperature of the thermostat is set at, for example, 210° C.

The operation of the thermostat is delayed in response to rapid temperature rise of the heat roller 1. This is because the thermostat is placed in the noncontact state relative to the heat roller 1 and because the large thermal capacity or endothermic properties of the thermostat, and-so on.

For example, in the case of the temperature rise speed of the heat roller 1 being 20° C./s, the thermostat operates when the temperature of the heat roller 1 reaches 420° C. In the case of the temperature rise speed of the heat roller 1 being 25° C./s, the thermostat operates when the temperature of the heat roller 1 reaches 450° C.

In the case of the temperature rise speed of the heat roller 1 being 30° C./s, the thermostat operates when the temperature of the heat roller 1 reaches 500° C. In the case of the temperature rise speed of the heat roller 1 being 35° C./s, the thermostat operates when the temperature of the heat roller 1 reaches 570° C.

The thermostat cannot prevent the heat roller 1 from catching fire in the case of the temperature rise speed of the heat roller 1 in the stopped state being about 50° C./s, and in the case where an ignition temperature of the heat roller 1 is, for example, 500° C.

However, according to the fixing device having the above-stated structure, when rotation of the heat roller 1 stops, the movement control section 4 moves the magnetic flux block section 5 to a position at which magnetic flux from the magnetic flux generating element 3 causes the heat roller 1 to generate no heat. On the other hand, when the heat roller 1 rotates, the movement control section 4 moves the magnetic flux block section 5 to a position at which the magnetic flux from the magnetic flux generating element 3 causes the heat roller 1 to generate heat Thereby, the magnetic flux generating element 3 is prevented from heat generation even if electric current is applied to the magnetic flux generating element 3 to generate magnetic flux from the magnetic flux generating element 3 when rotation of the heat roller 1 stops. Thus, smoking and firing of the heat roller 1 can be suppressed, so that it becomes possible to achieve a high-security fixing device.

Heat generation of the magnetic flux generating element 3 is reliably prevented when rotation of the heat roller 1 stops. This is because when rotation of the heat roller 1 stops, the movement control section 4 moves the magnetic flux block section 5 to a position at which magnetic flux flowing from the magnetic flux generating element 3 to the heat roller 1 is completely blocked.

The magnetic flux block section 5 has good responsiveness to the rotation of the heat roller 1 because the movement control section 4 moves the magnetic flux block section 5 in conjunction with the rotation of the heat roller 1. Thus, it becomes possible to swiftly and reliably move the magnetic flux block section 5 to the position at which the heat roller 1 generates no heat when rotation of the heat roller 1 stops.

The movement control section 4 constantly biases the magnetic flux block section 5 toward the position at which the heat roller 1 does not generate heat. Thereby, the magnetic flux block section 5 is prevented from staying at the position which causes the heat roller 1 to generate heat, so that the heat roller 1 is more reliably prevented from smoking and firing.

The movement control section 4 moves the magnetic flux block section 5 in such a way as to decrease an amount of a blocked magnetic flux flowing from the magnetic flux generating element 3 to the heat roller 1, as a rotation speed of the heat roller 1 increases. Therefore, a higher rotation speed of the heat roller 1 increases an amount of the magnetic flux flowing to the heat roller 1, so that a heating value of the heat roller 1 can be increased. Therefore, regardless of the rotation speed of the heat roller 1, it becomes possible to keep the temperature rise speed of the heat roller 1 constant. Generally, in the case where the amount of magnetic flux flowing to the heat roller 1 is constant, the higher rotation speed of the heat roller 1 reduces the temperature rise speed of the heat roller 1.

Moreover, the converter control section 8a is provided in order to turn off application of electric current to the converter 7 when rotation of the heat roller 1 stops. This makes it possible to reliably prevent generation of magnetic flux from the magnetic flux generating element 3 when rotation of the heat roller 1 stops.

### Second Embodiment

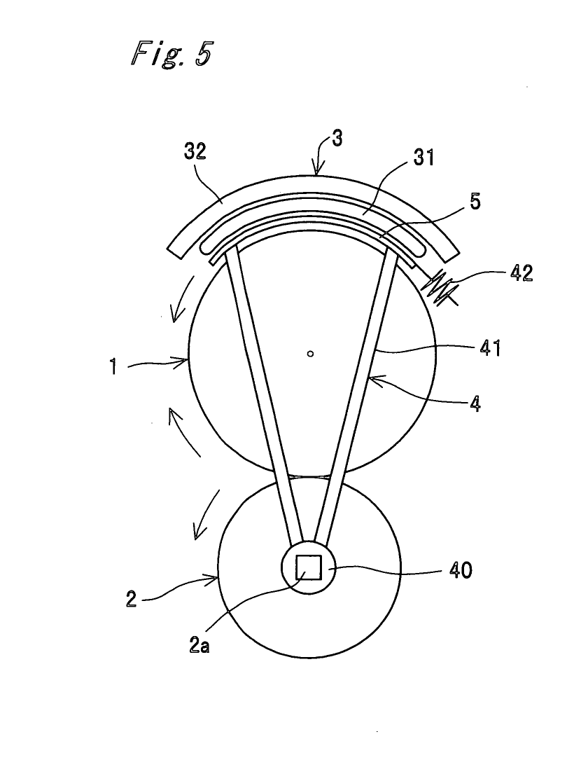

FIG. 5 shows a fixing device in a second embodiment of the present invention. The second embodiment is different, compared to the first embodiment, in that the movement control section 4 moves the magnetic flux block section 5 in conjunction with the rotation of the pressure roller 2.

In other words, the damper 40 is mounted on a shaft section 2a of the pressure roller 2. A turning force of the shaft section 2a of the pressure roller 2 is transmitted to the magnetic flux block section 5 through the damper 40. The magnetic flux block section 5 moves in conjunction with the pressure roller 2 which rotates following after the rotation of the heat roller 1.

Therefore, it is possible to determine whether or not the heat roller 1 rotates, based on whether or not the pressure roller 2 rotates. In addition, the pressure roller 2 has a function to transport the recording member S in pressure contact with the heat roller 1. Therefore, the pressure roller 2 may both fulfill the above-stated function and determine whether or not the heat roller 1 rotates, so that it becomes possible to reduce the number of component parts.

It is acceptable to mount the movement control section 4 on other rotor, which rotates following after the heat roller 1, than the pressure roller 2 in order to move the magnetic flux block section 5 in conjunction with the other rotor. The other rotor includes, for example, a rotor having a function of a cleaning rotor which cleans the heat roller 1 and the pressure roller 2 in the contact state with the heat roller 1 and the pressure roller 2.

### Third Embodiment

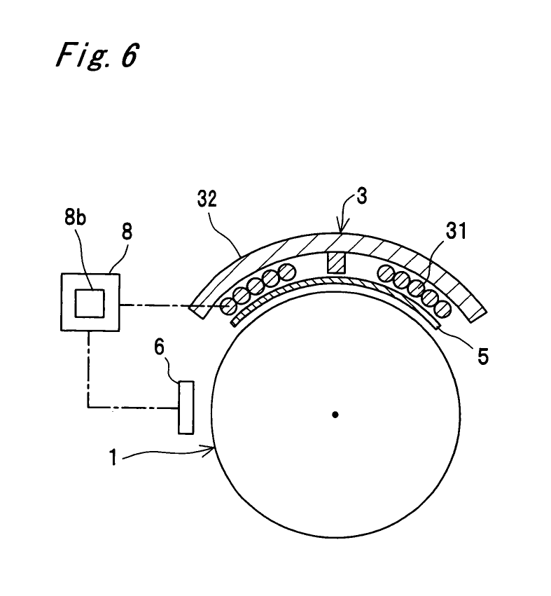

FIG. 6 shows a fixing device in a third embodiment of the present invention. In the third embodiment, as compared with the first embodiment, the main control section 8 has a coil control section 8b instead of the converter control section 8a. The coil control section 8b turns off application of electric current to the coil 31 when rotation of the heat roller 1 stops.

This makes it possible to reliably prevent generation of magnetic flux from the magnetic flux generating element 3 when rotation of the heat roller 1 stops. Also, the main control section 8 may have the coil control section 8b together with the converter control section 8a.

### Fourth Embodiment

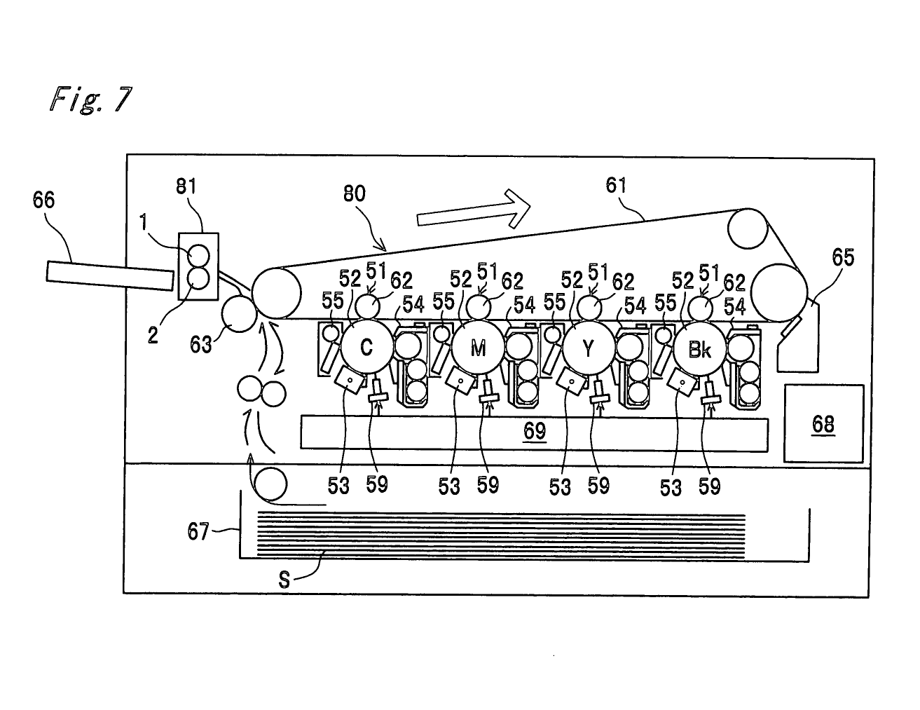

FIG. 7 is a simplified structure view of an image forming apparatus in another embodiment of the present invention. The image forming apparatus includes an imaging device 80 for forming an image by attaching unfixed toner t on the recording member S, and includes a fixing device 81 of the first embodiment for melting the toner t and fixing it onto the recording member S. The image forming apparatus is an electrophotographic four-color printer.

The image forming device 80 includes an intermediate transfer belt 61, four image forming units 51, a primary transfer section 62, and a secondary transfer section 63. The four image forming units 51 are disposed along the intermediate transfer belt 61 for forming toner images. The primary transfer section 62 transfers the toner images formed by the respective image forming units 51 onto the intermediate transfer belt 61. The secondary transfer section 63 transfers the images transferred onto the intermediate transfer belt 61 onto the recording member S.

The image forming unit 51 forming a black (BK) toner image, the image forming unit 51 for forming a yellow (Y) toner image, the image forming unit 51 for forming a magenta (M) toner image and the image forming unit 51 for forming a cyan (C) toner image are disposed in sequence along the upper stream toward the downs stream of the intermediate transfer belt 61.

Each of the image forming unit 51 includes a photoreceptor drum 52, a charging section 53 for uniformly charging the photoreceptor drum 52, an exposure section 59 for applying image exposure to the charged photoreceptor drum 52, and a development section 54 for developing an electrostatic latent image formed through exposure with the toner of respective colors.

The image forming apparatus includes a control device 68 for controlling the entire image forming apparatus and an exposure control device 69 for receiving signals corresponding to images sent from the control device 68. The exposure control device 69 drives each of the exposure sections 59 corresponding to the respective colors.

Description is now given of the actions of the image forming apparatus.

A toner image developed on the photoreceptor drum 52 of an image forming unit 51 is primary-transferred onto the intermediate transfer belt 61 at a position of contact with the intermediate transfer belt 61 by the primary transfer section 62.

The toner images transferred onto the intermediate transfer belt 61 are superimposed on top thereof with respective colors as the toner image passes the respective image forming units 51. Finally, a full-color toner image is formed on the intermediate transfer belt 61.

Thereafter, the full-color toner image on the intermediate transfer belt 61 is collectively subjected to secondary transfer onto the recording member S on the down stream side of the intermediate transfer belt 61 by the secondary transfer section 63.

Then, the recording member S passes through the fixing device 81 placed on the downstream side of a transportation path of the recording member S, and thereby the toner image is fixed. Thereafter, the recording member S is discharged onto a discharge tray 66.

The recording member S is housed in a cassette 67 in a lowermost section of the image forming apparatus and is transported one by one from the cassette 67 to the secondary transfer section 63.

After the primary transfer, the toner remaining on the photoreceptor drum 52 is removed by a cleaning section 55, whish is placed on the downstream side, so as to be collected from the lower side of the cleaning section 55.

After the secondary transfer, the toner remaining on the intermediate transfer belt 61 is removed from the intermediate transfer belt 61 by a cleaning blade 65, and is transported by an unshown transportation screw so as to be collected in an unshown waste toner container.

The thus-structured image forming apparatus is provided with the fixing device 81 of the first embodiment of the present invention, so that it becomes possible to prevent smoking and firing from the fixing device 81 to ensure high security. The fixing device in either the second embodiment or the fifth embodiment may be employed as a fixing device of the image forming apparatus.

It should be noted that the present invention is not limited to the above-stated embodiments. For example, the damper 40 may be a pressure damper instead of the disc damper. The pressure damper generates a torque by using the pressure of oil inside thereof. The pressure damper has a mechanism to adjust a flow amount and a flow direction of the oil so as to change the torque according to the rotation direction and the rotation speed of the roller.

Also, the heating element and the pressing element may be a belt instead of the roller. Further, the magnetic flux generating element 3 may be placed inside the heating element.

Furthermore, when rotation of the heat roller 1 stops, magnetic flux need only be blocked by the magnetic flux block section 5 to the extent that the heat roller 1 does not generate heat. Moreover, the magnetic flux block section 5 may electrically be moved by the movement control section 4.

The image forming apparatus may be any one of monochrome/color copiers, printers, facsimiles and compound machines thereof.

The invention being thus described, it will be obvious that the invention may be varied in many ways. Such variations are not be regarded as a departure from the spirit and scope of the invention, and all such modifications as would be obvious to one skilled in the art are intended to be included within the scope of the following claims.

What is claimed is:

1. A fixing device, comprising:
a magnetic flux generating element for generating magnetic flux;
a rotatable heating element for generating heat by magnetic flux from the magnetic flux generating element;
a magnetic flux block section placed movably into between the magnetic flux generating element and the heating element, and blocking at least part of the magnetic flux flowing from the magnetic flux generating element to the heating element when being positioned between the magnetic flux generating element and the heating element;
a movement control section for moving the magnetic flux block section to a position at which the magnetic flux from the magnetic flux generating element causes the heating element to generate no heat when rotation of the heating element stops, whereas moving the magnetic flux block section to a position at which the magnetic flux from the magnetic flux generating element causes the heating element to generate heat when the heating element rotates.

2. The fixing device according to claim 1, wherein
the movement control section moves the magnetic flux block section in such a way that an amount of blocked magnetic flux flowing from the magnetic flux generating element to the heating element decreases as a rotation speed of the heating element increases.

3. The fixing device according to claim 1, wherein
the movement control section moves the magnetic flux block section in conjunction with rotation of the heating element.

4. The fixing device according to claim 1, wherein
when rotation of the heating element stops, the movement control section moves the magnetic flux block section to a position at which the magnetic flux flowing from the magnetic flux generating element to the heating element is completely blocked.

5. The fixing device according to claim 1, further comprising
another rotor which rotates following after rotation of the heating element, wherein
the movement control section moves the magnetic flux block section in conjunction with rotation of the rotor.

6. The fixing device according to claim 1, wherein
the magnetic flux generating element has a coil, and
a coil control section is provided for turning off application of electric current to the coil when rotation of the heating element stops.

7. The fixing device according to claim 1, wherein
the magnetic flux generating element has a coil,
the coil is connected to a converter, and
a converter control section is provided for turning off application of electric current to the converter when rotation of the heating element stops.

8. An image forming apparatus comprising the fixing device according to claim 1.
